(19) United States
(12) Patent Application Publication
(10) Pub. No.: US 2024/0373932 A1
(43) Pub. Date: Nov. 14, 2024

(54) ATOMIZATION HEATING ASSEMBLY AND ATOMIZATION HEATING DEVICE USING SAME

(71) Applicant: SHENZHEN HUACHENGDA PRECISION INDUSTRY CO. LTD., Shenzhen (CN)

(72) Inventor: Ping CHEN, Shenzhen (CN)

(73) Assignee: SHENZHEN HUACHENGDA PRECISION INDUSTRY CO. LTD., Shenzhen, GD (CN)

(21) Appl. No.: 18/564,622

(22) PCT Filed: Nov. 19, 2021
(86) PCT No.: PCT/CN2021/131915

§ 371 Date: Nov. 28, 2023

(51) Int. Cl. A24F 40/465; A24F 40/10; A24F 40/44; A24F 40/48; H05B 6/10

(52) U.S. Cl. CPC A24F 40/465; A24F 40/10; A24F 40/44; A24F 40/48; H05B 6/108

(57) ABSTRACT

Disclosed are an atomization heating assembly and an atomization heating device using the same. The atomization heating assembly includes a porous liquid transfer unit and a magnetically conductive porous heating unit. The porous liquid transfer unit is configured as a porous structure with micron-sized pores formed by high-temperature sintering of an inorganic non-metallic aggregate and a binder, the magnetically conductive porous heating unit is configured as a magnetically conductive porous structure formed by direct high-temperature sintering of magnetically conductive material particles or by high-temperature sintering of the magnetically conductive material particles and the binder, the magnetically conductive porous heating unit is inlaid in or attached to a surface of the porous liquid transfer unit. The atomization heating assembly adopts an electromagnetic heating mode, thereby simplifying the structure of atomizers and reducing the cost of the atomizers.

### FIELD

The invention relates to the technical field of atomization, in particular to an atomization heating assembly and an atomization heating device using the same.

### BACKGROUND

As a new atomization technique emerged in recent years, the electrical heating atomization technique heats and atomizes liquid into atomized steam by means of heat energy generated by the thermal effect of resistance and has been widely applied to medical products, intelligent household appliances and consumer electronic products. The electrical heating modes include a resistance heating mode and an electromagnetic heating mode. In a case of electromagnetic induction heating, an alternating magnetic field is generated by components of an electronic circuit board, and when a magnetically conductive metal material is placed in the alternating magnetic field, alternating current and eddy current will be produced on the surface of the magnetically conductive metal material, carriers in a magnetic conductor move irregularly under the action of the eddy current to collide with atoms, and heat energy is generated by friction between the carriers and the atoms. Because resistance heating is limited by the resistance of a heating unit, the material of the heating unit is limited, and heat generated by the heating unit has a great connection with the sectional area of a conductor and other factors. The heating unit often needs to be connected to an external power supply, so heat generated by the heating unit is limited by the resistance of a product. In addition, a liquid transfer material generally needs to be attached to or inlaid in a porous material to guarantee normal use, and once the liquid transfer material is separated from the porous material by heating, the problem of drying burning of an atomization core will be easily caused by the heating unit.

### SUMMARY

In view of the defects in the prior art, the technical issue to be settled by the invention is to provide an atomization heating assembly and an atomization heating device using the same. A liquid transfer unit and a heating unit which are easy to use are provided by means of the electromagnetic heating mode, and the function of the liquid transfer unit and the function of the heating unit are integrated, thus simplifying the structure of atomizers and reducing the cost of the atomizers.

The technical solution adopted by the invention to settle the technical issue is to provide an atomization heating assembly which comprises a porous liquid transfer unit and a magnetically conductive porous heating unit. The porous liquid transfer unit is configured as a porous structure with micron-sized pores formed by high-temperature sintering of an inorganic non-metallic aggregate and a binder. The magnetically conductive porous heating unit is configured as a magnetically conductive porous structure formed by direct high-temperature sintering of magnetically conductive material particles or by high-temperature sintering of the magnetically conductive material particles and the binder. The magnetically conductive porous heating unit is at least inlaid in or attached to a surface of the porous liquid transfer unit, and an exposed surface of the magnetically conductive porous heating unit located in an atomization passage forms an atomization surface.

Further, in the atomization heating assembly, preferably, the magnetically conductive porous heating unit is prepared from the following raw materials: 50-100 parts of a magnetically conductive metal powder, 0-30 parts of a ceramic powder, 0-40 parts of a sintering aid, and 0-30 parts of paraffin.

Further, the magnetically conductive metal powder is at least one of pure iron, low-carbon steel, iron-aluminum alloy, iron-silicon alloy, iron-nickel alloy, iron-cobalt alloy, ferrite, metallic nickel, and metallic cobalt.

Further, in the atomization heating assembly, preferably, the binder is a glass powder or a glaze, and has a melting point of 600-1300° C.

Further, in the atomization heating assembly, preferably, a portion, in contact with a sealing element, of the surface of the porous liquid transfer unit is not provided with the magnetically conductive porous heating unit.

Further, in the atomization heating assembly, preferably, a thickness of the porous liquid transfer unit is greater than that of the magnetically conductive porous heating unit.

Further, in the atomization heating assembly, preferably, a thickness of a portion, provided with the atomization surface, of the magnetically conductive porous heating unit is greater than that of other portions of the magnetically conductive porous heating unit.

Further, in the atomization heating assembly, preferably, an air guide member configured to guide air and enlarge the atomization area is arranged on the atomization surface of the magnetically conductive porous heating unit in an airflow direction.

Further, in the atomization heating assembly, preferably, multiple columns of said air guide members are arranged in the airflow direction, and gaps are reserved between the multiple columns of said air guide members.

Further, in the atomization heating assembly, preferably, in the airflow direction, the air guide members in a same column are arranged discontinuously or continuously.

Further, in the atomization heating assembly, preferably, the air guide member is arranged in parallel, radially, or in a staggered manner.

Further, in the atomization heating assembly, preferably, a cross-section of the air guide member is in a polygonal shape, a curved shape or a combination thereof.

Further, in the atomization heating assembly, preferably, the air guide member is at least one of an air guide groove, an air guide rib, and an air guide protrusion.

Further, in the atomization heating assembly, preferably, the porous liquid transfer unit is configured as a plate structure, a bowl-shaped structure, a grooved structure or a cylindrical structure.

Further, in the atomization heating assembly, preferably, the magnetically conductive porous heating unit is configured as a plate structure inlaid in a middle of a side wall of the porous liquid transfer unit, or the magnetically conductive porous heating unit configured as a cylindrical structure inlaid in a middle of an inner wall or an outer wall of the porous liquid transfer unit.

Further, in the atomization heating assembly, preferably, the atomization surface of the magnetically conductive porous heating unit extends out of a side surface of the porous liquid transfer unit or is flush with the side surface of the porous liquid transfer unit.

Further, in the atomization heating assembly, preferably, a liquid inflow surface arranged on the porous liquid transfer unit is at least one of a flat surface, a curved surface and a groove surface, and the atomization surface is at least one of a flat surface and a curved surface.

Further, in the atomization heating assembly, preferably, a liquid transfer hole or a liquid transfer groove is preferably formed in a liquid inflow surface of the porous liquid transfer unit.

An atomization heating device, comprises a housing, a mouthpiece and a liquid tank. The atomization heating assembly described above is arranged below the liquid tank, and a sealing element is arranged between the atomization heating assembly and the liquid tank.

The invention has the following beneficial effects: the invention provides an atomization heating assembly, comprising a porous liquid transfer unit and a magnetically conductive porous heating unit; the porous liquid transfer unit is configured as a porous structure formed by high-temperature sintering of an inorganic non-metallic aggregate and a binder, the magnetically conductive porous heating unit is configured as a magnetically conductive porous structure formed by direct high-temperature sintering of magnetically conductive material particles or by high-temperature sintering of the magnetically conductive material particles and the binder, the magnetically conductive porous heating unit is at least inlaid in or attached to a surface of the porous liquid transfer unit, and an exposed surface of the magnetically conductive porous heating unit located in an atomization passage forms an atomization surface. A liquid transfer unit and a heating unit which are easy to use are provided by means of an electromagnetic heating mode, and the function of the liquid transfer unit and the function of the heating unit are integrated, thus simplifying the structure of atomizers and reducing the cost of the atomizers.

### BRIEF DESCRIPTION OF THE DRAWINGS

The invention will be further described below in conjunction with accompanying drawings and embodiments. In the drawings:

FIG. 1 is a sectional view according to a first implementation of an atomization heating assembly in Embodiment 1 of the invention;

FIG. 2 is a sectional view according to a second implementation of the atomization heating assembly in Embodiment 1 of the invention;

FIG. 3 is a three-dimensional structural view according to a third implementation of the atomization heating assembly in Embodiment 1 of the invention;

FIG. 4 is a top view according to a third implementation of the atomization heating assembly in Embodiment 1 of the invention;

FIG. 5 is a three-dimensional structural view according to a fourth implementation of the atomization heating assembly in Embodiment 1 of the invention;

FIG. 6 is a top view according to a fourth implementation of the atomization heating assembly in Embodiment 1 of the invention;

FIG. 7 is a three-dimensional structural view of a fifth implementation of the atomization heating assembly in Embodiment 1 of the invention;

FIG. 8 is an exploded view of an atomization heating device in Embodiment 2 of the invention; and

FIG. 9 is a sectional view of the atomization heating device in Embodiment 2 of the invention.

### DESCRIPTION OF THE EMBODIMENTS

To gain a better understanding of the technical features, objectives and effects of the invention, specific implementations of the invention will be described in detail with reference to the accompanying drawings.

When one element is referred to as being “fixed to” or “arranged on” the other element, it may be directly or indirectly located on the other element. When one element is referred to as being “connected to” the other element, it may be directly or indirectly connected to the other element.

Terms such as “upper”, “lower”, “left”, “right”, “front”, “back”, “vertical”, “horizontal”, “top”, “bottom”, “inner” and “outer” are used to indicate directions or positions based on the accompanying drawings.

The term “axial” and “radial” refer to a length direction of a whole device or component, and the term “radial” refers to a direction perpendicular to the axial direction.

Terms such as “first” and “second” are merely for the purpose facilitating description, and should not be construed as indicating or implying relative importance or implicitly indicating the number of technical features referred to. Unless otherwise expressly defined, “multiple” means two or more.

The above terms are merely for facilitating description, and should not be construed as limitations of the technical solutions of the invention.

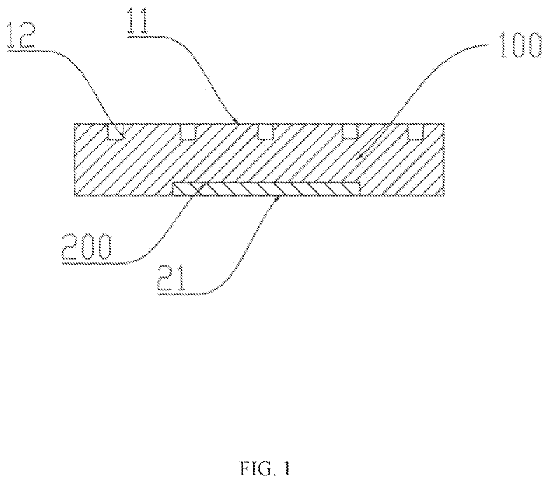

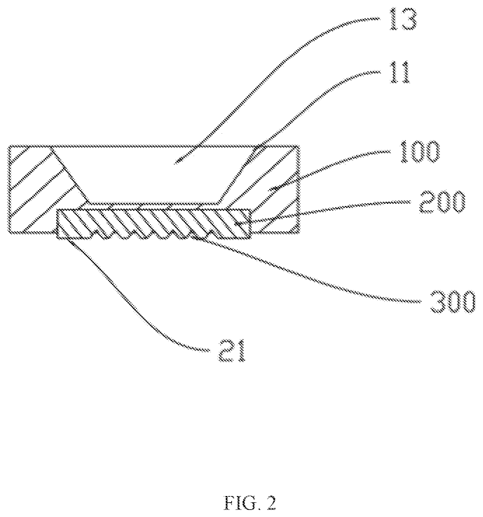

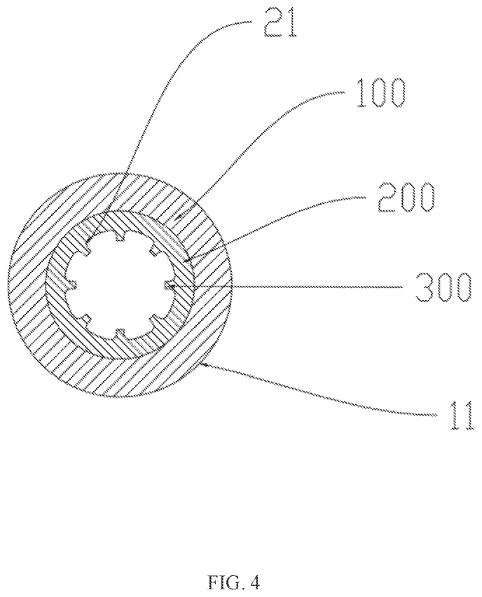

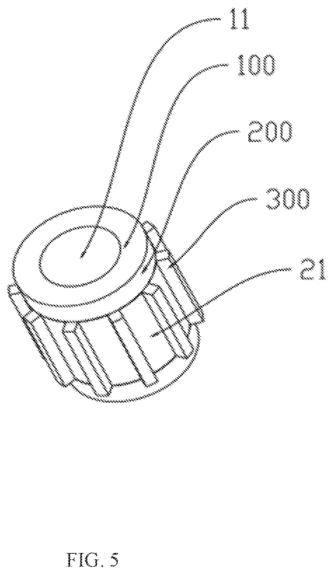

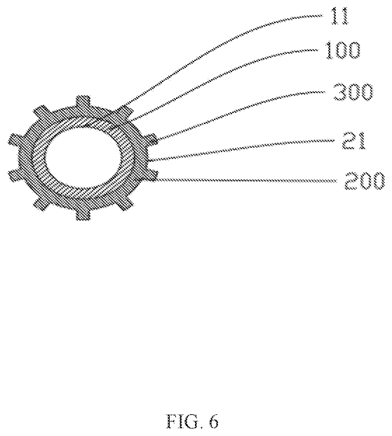

Embodiment 1: As shown in FIGS. 1-7, an atomization heating assembly comprises a porous liquid transfer unit 100 and a magnetically conductive porous heating unit 200. Wherein, the porous liquid transfer unit 100 is configured as a porous structure with micron-sized pores formed by high-temperature sintering of an inorganic non-metallic aggregate and a binder. The micron-sized pores formed after high-temperature sintering of the inorganic non-metallic aggregate and the binder can provide passages allowing liquid to be atomized to flow through, and the porous liquid transfer unit 100 with high strength can provide a structural support and has heat insulation effects. The magnetically conductive porous heating unit 200 is configured as a magnetically conductive porous structure formed by direct high-temperature sintering of magnetically conductive material particles or by high-temperature sintering of magnetically conductive material particles and a binder. That is, the magnetically conductive porous structure may be achieved by direct high-temperature sintering of magnetically conductive material particles or by high-temperature sintering of magnetically conductive material particles and a binder, and micron-sized micropores are formed in both cases. The magnetically conductive structure formed in this way not only can generate heat by electromagnetic induction, but also can fulfil a liquid transfer function by means of the micron-sized micropores. The magnetically conductive porous heating unit 200 is at least inlaid in or attached to a surface of the porous liquid transfer unit 100. It can be understood that the magnetically conductive porous heating unit 200 may be inlaid in or attached to any surface of the porous liquid transfer unit 100. Multiple magnetically conductive porous heating units 200 may be arranged at intervals or one magnetically conductive porous heating unit 200 may be arranged continuously. Multiple magnetically conductive porous heating units 200 may be inlaid in or attached to one surface of the porous liquid transfer unit 100, or multiple magnetically conductive porous heating units 200 may be inlaid in or attached to different surfaces of the porous liquid transfer unit 100. As shown in FIG. 2, “inlaid” in the invention may refer to “partially inlaid”, that is, one part of the magnetically conductive porous heating unit 200 is buried in the porous liquid transfer unit 100, and the other part of the magnetically conductive porous heating unit 200 extends out of the surface of the porous liquid transfer unit 100. As shown in FIG. 1, “inlaid” may also refer to “entirely inlaid”, that is, the magnetically conductive porous heating unit 200 is entirely arranged in the porous liquid transfer unit 100, which means that the surface of the magnetically conductive porous heating unit 200 is flush with the porous liquid transfer unit 100. The magnetically conductive porous heating unit 200 may be arranged on the surface of the porous liquid transfer unit 100 continuously or discontinuously. The magnetically conductive porous heating unit 200 may be arranged on all the surfaces of the porous liquid transfer unit 100, that is, the magnetically conductive porous heating unit 200 may be arranged on each surface of the porous liquid transfer unit 100, or arranged on part of the surfaces of the porous liquid transfer unit 100, or arranged on a part of any one surface of the porous liquid transfer unit 100 An exposed surface of the magnetically conductive porous heating unit 200 located in an atomization passage forms an atomization surface 21. It can be understood that the magnetically conductive porous heating unit 200 is arranged in the atomization passage, and the exposed surface of the magnetically conductive porous heating unit 200 is the atomization surface 21. The magnetically conductive porous heating unit 200, as a heating layer, has the characteristic of multiple micropores, magnetically conductive metal particles in the magnetically conductive porous heating unit 200 can generate heat due to the electromagnetic effect, and the multiple micropores ensure that liquid can be supplied sufficiently and atomized steam can flow out of the micropores smoothly, so the heating layer may be designed into a whole surface capable of generating heat to realize higher heat efficiency under the same area, and the magnetically conductive porous heating unit 200 at other positions have both a liquid transfer function and a heating function and can be used as a pre-heating element to preheat and atomize liquid in the porous liquid transfer unit 100 where the magnetically conductive porous heating unit 200 is inlaid or attached, thus improving the atomization effect and the taste of atomized steam. When the atomization heating assembly works, the porous liquid transfer unit 100 transfers cigarette liquid to be atomized to the atomization surface 21 of the magnetically conductive porous heating unit 200, the magnetically conductive porous heating unit 200 generates heat by means of the electromagnetic effect to atomize the cigarette liquid into atomized steam, and the atomized steam is mixed with air to form aerosol, which is eventually inhaled by users.

The magnetically conductive porous heating unit 200 not only can be inlaid in or attached to the surface of the porous liquid transfer unit 100, but also can be buried in the porous liquid transfer unit 100 to preheat liquid to increase the flow rate of the liquid, such that the liquid can be transferred to the atomization surface 21 more quickly.

Preferably, a portion, in contact with a sealing element 50, of the surface of the porous liquid transfer unit 100 is not provided with the magnetically conductive porous heating unit 200. Since the sealing element 50 is mostly made from rubber or plastic, the magnetically conductive porous heating unit 200 is not arranged on the portion, in contact with a sealing element 50, of the surface of the porous liquid transfer unit 100 to prevent the sealing element 50 against deformation or damage caused by continuous heating of the magnetically conductive porous heating unit 200, which may otherwise compromise the sealing effect of the sealing element 50.

The thickness of the porous liquid transfer unit 100 is greater than that of the magnetically conductive porous heating unit 200. The porosity of the porous liquid transfer unit 100 is 30%-70%, and the diameter of the micropores is 5-100 μm. The thickness of the porous liquid transfer unit 100 is better to be higher than that of the magnetically conductive porous heating unit 200 as the atomization temperature of cigarette liquid is generally 180-260° C., the temperature of the magnetically conductive porous heating unit 200 will be high when reaching the atomization temperature, and the porous liquid transfer unit 100 with a large size or thickness will heat up slowly, the porous liquid transfer unit 100 is connected with a liquid chamber of an atomization device and the liquid chamber is generally made from a material capable of withstanding a temperature of about 120° C., and the porous liquid transfer unit 100 needs to be thick enough to serve as a heat insulation material.

In addition, the thickness of a portion, provided with the atomization surface 21, of the magnetically conductive porous heating unit 200 is greater than that of other portions of the magnetically conductive porous heating unit 200, such that the heating temperature in unit area of the portion, provided with the atomization surface 21, of the magnetically conductive porous heating unit 200 is higher than the temperature of other portions of the magnetically conductive porous heating unit 200. The portion, provided with the atomization surface 21, of the magnetically conductive porous heating unit 200 is mainly used for heating and atomization and requires a high heating temperature in unit area, so this portion needs to be set to have a large thickness. Other portions of the magnetically conductive porous heating unit 200 can be used for preheating liquid to be atomized and requires a low heating temperature in unit area, so the thickness of these portions can be smaller than that of the portion, provided with the atomization surface 21, of the magnetically conductive porous heating unit 200.

An air guide member 300 configured to guide air and enlarge the atomization area is arranged on the atomization surface 21 of the magnetically conductive porous heating unit 200 in the airflow direction. Different from traditional heating units, the magnetically conductive porous heating unit 200 adopts electromagnetic heating, which is independent of resistance and only related to the magnetic permeability and electromagnetic switching frequency, and in the heating atomization process, the temperature of the magnetically conductive porous heating unit 200 will rise continuously over the heating time while the temperature should be kept relatively constant for atomization, which requires quick heat dissipation of the magnetically conductive porous heating unit 200, so the air guide member 300 is preferably arranged on the atomization surface 21 of the magnetically conductive porous heating unit 200. The air guide member 300 can facilitate to guide air and enlarge the atomization area, thus improving the atomization capacity. The air guide member 300 can also enlarge the contact area between a heating surface and air to promote heat dissipation of the magnetically conductive porous heating unit 200, atomized steam can be taken away by air quickly to be prevented from being accumulated in an atomization chamber, and dry burning caused by a high temperature is avoided.

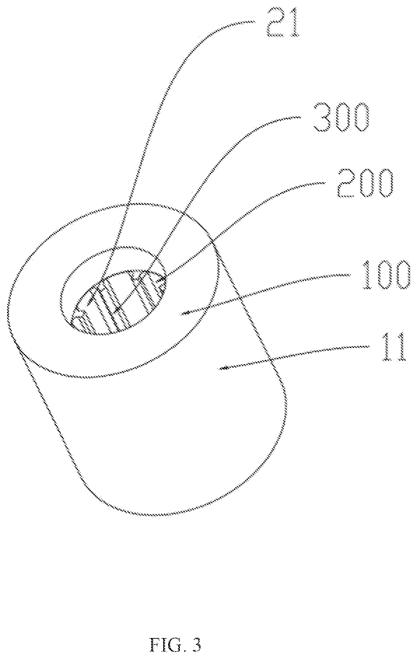

The air guide member 300 is at least one of an air guide groove, an air guide rib and an air guide protrusion. As shown in FIG. 2, the air guide member 300 may be an air guide groove, the extension direction of the air guide groove is consistent with the airflow direction, and the air guide groove forms an air guide passage. Multiple air guide grooves may be arranged, gaps are reserved between the air guide grooves, and air flows along the air guide grooves, thus increasing the flow rate of air. As shown in FIG. 3, the air guide member 300 may be an air guide rib, multiple air guide ribs are arranged, gaps are reserved between the air guide ribs to form air guide passages, and air flows along the air guide passages, thus increasing the flow rate of air. The air guide member 300 may be an air guide protrusion, multiple air guide protrusions are arranged, gaps are reserved between the air guide protrusions to form air guide passages, and air flows along the air guide passages, thus increasing the flow rate of air. Multiple columns of air guide members 300 may be arranged in the airflow direction, gaps are reserved between the multiple columns of air guide members 300 to form air guide passages, and in the airflow direction, the air guide members 300 in the same column may be arranged discontinuously or continuously, preferably continuously to realize a better air guide effect. There are many implementations of the arrangement of the air guide members 300. The air guide members 300 may be arranged in parallel, that is, the air guide members 300 are parallel to each other. The air guide members 300 may be arranged radially, which means that multiple air guide members 300 radiate from one side to the other side of the magnetically conductive porous heating unit in the airflow direction; or, the air guide members 300 are arranged in a staggered manner, that is, the air guide members 300 are staggered with each other as long as the direction of the air guide passages formed by the air guide members 300 is identical to the airflow direction. The cross-section of the air guide member 300 is in a polygonal shape, a curved shape, or a combination thereof.

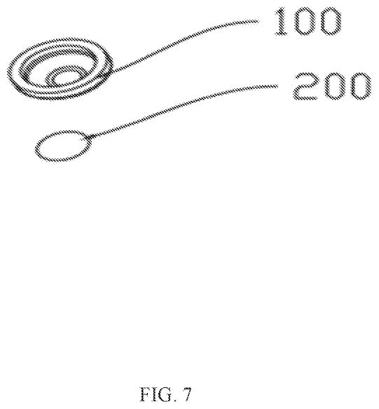

There are many implementations of the porous liquid transfer unit 100. As shown in FIG. 1, the porous liquid transfer unit 100 is configured as a plate structure, in this case, a liquid inflow surface 11 arranged on the porous liquid transfer unit 100 is configured as a planar structure, and correspondingly, the magnetically conductive porous heating unit 200 is configured as a plate structure inlaid in or attached to the middle of a side wall of the porous liquid transfer unit 100, and the atomization surface 21 is configured as a planar structure. Or, as shown in FIGS.3-6, the porous liquid transfer unit 100 is configured as a cylindrical structure, in this case, the liquid inflow surface 11 arranged on the porous liquid transfer unit 100 is configured as a curved structure, and correspondingly, the magnetically conductive porous heating unit 200 is configured as a cylindrical structure inlaid in or attached to the middle of an inner wall of the porous liquid transfer unit 100 or is configured as a cylindrical structure attached to or inlaid in the middle of an outer wall of the porous liquid transfer unit 100, and the atomization surface 21 is configured as a curved structure. Or, as shown in FIG. 2, the porous liquid transfer unit 100 may be configured as a grooved structure. It can be understood that the porous liquid transfer unit 100 is provided with a liquid transfer groove 13. In this case, the liquid inflow surface 11 arranged on the porous liquid transfer unit 100 is configured as a groove surface structure, and correspondingly, the magnetically conductive porous heating unit 200 is inlaid in or attached to the porous liquid transfer unit 100 corresponding to the liquid transfer groove. Or, as shown in FIG. 7, the porous liquid transfer unit 100 may be configured as bowl-shaped structure, and correspondingly, the magnetically conductive porous heating unit 200 the magnetically conductive porous heating unit 200 is inlaid in or attached to the bottom or outer wall of the bowl-shaped porous liquid transfer unit 100. The liquid inflow surface 11 arranged on the porous liquid transfer unit 100 may be a flat surface, a curved surface, even a groove surface, or other structures, which is not specifically limited here. The atomization surface 21 may be a flat surface, a curved surface, an inclined surface, or a combination thereof, which is not specifically limited here and can be designed as actually needed.

As shown in FIG. 1-FIG. 2, a liquid transfer hole 12 or a liquid transfer groove 13 may be formed in the liquid inflow surface 11 of the porous liquid transfer unit 100 to realize a better liquid inflow effect. The design of the liquid transfer groove 13 or/and the liquid transfer hole 12 is especially important for the porous liquid transfer unit and can enlarge the surface area of the liquid inflow surface 11 of the porous liquid transfer unit 100, thus facilitating control of the liquid inflow rate and improving the liquid inflow stability. Particularly in some cases where the liquid inflow surface 11 of the porous liquid transfer body 100 is arranged obliquely and has liquid hold time shorter than that of the planar or bowl-shaped liquid inflow surface, the addition of the liquid transfer groove 13 or/and the liquid transfer hole 12 can improve the liquid inflow efficiency and stability.

A preparation method of the atomization heating assembly comprises: preparing porous liquid transfer unit 100 slurry from an inorganic non-metallic aggregate and a binder, preparing magnetically conductive porous heating unit 200 slurry from magnetically conductive material particles or magnetically conductive material particles and a binder, performing hot pressing injection molding on the magnetically conductive porous heating unit 200 slurry with a mold to obtain the magnetically conductive porous heating unit 200, after the magnetically conductive porous heating unit 200 is cooled and fixed, injecting the porous liquid transfer unit 100 slurry to obtain an atomization heating assembly blank material by molding, and sintering the atomization heating assembly blank material at a high temperature in a high-temperature sintering furnace to obtain the atomization heating assembly.

Common materials of the inorganic non-metallic aggregate include molten quartz sand, diatomite, talc, zeolite, sepiolite, maifanite, cordierite, silicon oxide, zirconia and other high-temperature refractory ceramic powders, and the binder is a glass powder or a glaze and has a melting point of 600-1300° C.

The magnetically conductive porous heating unit 200 is prepared from the following raw materials: 50-100 parts of a magnetically conductive metal powder, 0-30 parts of a ceramic powder, 0-40 parts of a sintering aid, and 0-30 parts of paraffin. The magnetically conductive metal powder is at least one of pure iron, low-carbon steel, iron-aluminum alloy, iron-silicon alloy, iron-nickel alloy, iron-cobalt alloy, ferrite, metallic nickel and metallic cobalt, which have good stability with the frequency change of the initial magnetic permeability, and have good magnetic induction and high magnetic permeability. It can be understood that the magnetically conductive metal powder may be any one of these metal powders, or a combination of any two or more of these metal powders. The magnetically conductive porous heating unit 200 is prepared by: mixing a plurality of parts of the magnetically conductive metal powder, a plurality of parts of the ceramic powder, a plurality of parts of the sintering aid, and a plurality of parts of the paraffin, and sintering the raw materials at a high sintering temperature of 600-1300° C. to form a magnetically conductive porous structure. Some specific embodiments and performance test results are shown in the table below:

TABLE 1
Specific embodiments and performance test results
of the magnetically conductive porous heating unit

| | Magnetically | | | | Performance test | |
|---|---|---|---|---|---|---|
| | conductive | Ceramic | Sintering | | | Average |
| | metal powder | powder | aid | Paraffin | Porosity | pore |
| Item | (parts) | (parts) | (parts) | (parts) | % | size/μm |
| Embodiment 1 | 50 | 0 | 0 | 0 | 38 | 9.3541 |
| Embodiment 2 | 60 | 30 | 0 | 0 | 42 | 9.7856 |
| Embodiment 3 | 55 | 0 | 40 | 0 | 57 | 8.3421 |
| Embodiment 4 | 85 | 0 | 0 | 30 | 46 | 10.1247 |
| Embodiment 5 | 75 | 15 | 20 | 16 | 67 | 7.0134 |
| Embodiment 6 | 80 | 20 | 10 | 20 | 69 | 8.6953 |
| Embodiment 7 | 95 | 10 | 30 | 10 | 53 | 7.9632 |
| Embodiment 8 | 68 | 25 | 1 | 0 | 47 | 7.2311 |
| Embodiment 9 | 92 | 0 | 15 | 27 | 34 | 5.3217 |
| Embodiment 10 | 88 | 7 | 25 | 2 | 42 | 54.2134 |

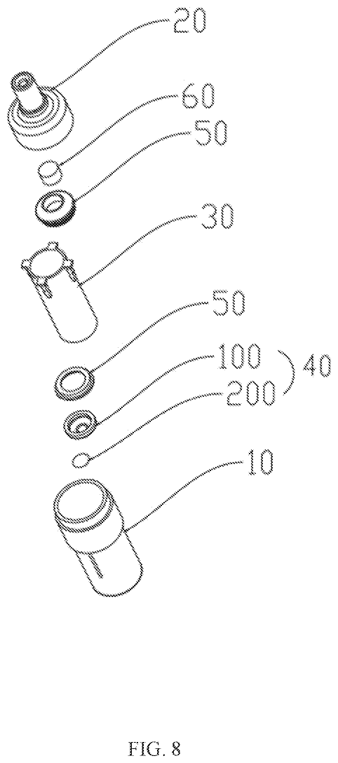

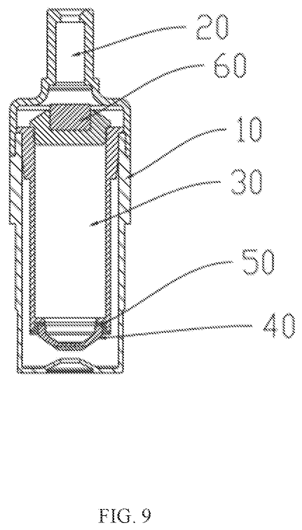

Embodiment 2: As shown in FIG. 8 and FIG. 9, an atomization heating device comprises a housing 10, a mouthpiece 20 and a liquid tank 30, wherein the atomization beating assembly 40 in Embodiment 1 is arranged below the liquid tank 30, the atomization heating assembly 40 comprises a porous liquid transfer unit 100 and a magnetically conductive porous heating unit 200, a sealing element 50 is arranged between the atomization heating assembly 40 and the liquid tank 30, a sealing element 50 is arranged between the liquid tank 30 and the mouthpiece 20, an air passage is formed between the corresponding sealing element 50 and the mouthpiece 20, liquid adsorption cotton 60 for adsorbing non-atomized cigarette liquid is arranged at an air outlet end of the corresponding sealing element 50 to improve the smoking experience of users, cigarette liquid is stored in the liquid tank 30, the liquid tank 30 supplies liquid to the atomization heating assembly 40, and the atomization heating assembly 40 is sealed by the corresponding sealing element 50 to prevent liquid from leaking or seeping out of the atomization heating assembly 40. When the atomization heating device works, air enters the atomization heating assembly 40 from the housing 10, the liquid tank 30 supplies liquid to the atomization heating assembly 40, the porous liquid transfer unit 100 transfers cigarette liquid to the magnetically conductive porous heating unit 200, the magnetically conductive porous heating unit 200 by electromagnetic induction to atomize the cigarette liquid to form atomized steam, the atomized steam is mixed with air to form aerosol, and the aerosol flows to the mouthpiece 20 along the air passage to be eventually inhaled by users.

1. An atomization heating assembly, comprising a porous liquid transfer unit and a magnetically conductive porous heating unit, wherein the porous liquid transfer unit is configured as a porous structure with micron-sized pores formed by high-temperature sintering of an inorganic non-metallic aggregate and a binder, the magnetically conductive porous heating unit is configured as a magnetically conductive porous structure formed by direct high-temperature sintering of magnetically conductive material particles or by high-temperature sintering of the magnetically conductive material particles and the binder, the magnetically conductive porous heating unit is at least inlaid in or attached to a surface of the porous liquid transfer unit, and an exposed surface of the magnetically conductive porous heating unit located in an atomization passage forms an atomization surface.

2. The atomization heating assembly according to claim 1, wherein the magnetically conductive porous heating unit is prepared from the following raw materials: 50-100 parts of a magnetically conductive metal powder, 0-30 parts of a ceramic powder, 0-40 parts of a sintering aid, and 0-30 parts of paraffin.

3. The atomization heating assembly according to claim 2, wherein the magnetically conductive metal powder is at least one of pure iron, low-carbon steel, iron-aluminum alloy, iron-silicon alloy, iron-nickel alloy, iron-cobalt alloy, ferrite, metallic nickel, and metallic cobalt.

4. The atomization heating assembly according to claim 1, wherein the binder is a glass powder or a glaze, and has a melting point of 600-1300° C.

5. The atomization heating assembly according to claim 1, wherein a portion, in contact with a sealing element, of the surface of the porous liquid transfer unit is not provided with the magnetically conductive porous heating unit.

6. The atomization heating assembly according to claim 1, wherein a thickness of the porous liquid transfer unit is greater than that of the magnetically conductive porous heating unit.

7. The atomization heating assembly according to claim 1, wherein a thickness of a portion, provided with the atomization surface, of the magnetically conductive porous heating unit is greater than that of other portions of the magnetically conductive porous heating unit.

8. The atomization heating assembly according to claim 1, wherein an air guide member configured to guide air and enlarge the atomization area is arranged on the atomization surface of the magnetically conductive porous heating unit in an airflow direction.

9. The atomization heating assembly according to claim 8, wherein multiple columns of said air guide members are arranged in the airflow direction, and gaps are reserved between the multiple columns of said air guide members.

10. The atomization heating assembly according to claim 9, wherein in the airflow direction, the air guide members in a same column are arranged discontinuously or continuously.

11. The atomization heating assembly according to claim 9, wherein the air guide member is arranged in parallel, radially, or in a staggered manner.

12. The atomization heating assembly according to claim 8, wherein a cross-section of the air guide member is in a polygonal shape, a curved shape or a combination thereof.

13. The atomization heating assembly according to claim 8, wherein the air guide member is at least one of an air guide groove, an air guide rib, and an air guide protrusion.

14. The atomization heating assembly according to claim 1, wherein the porous liquid transfer unit is configured as a plate structure, a bowl-shaped structure, a grooved structure or a cylindrical structure;
the magnetically conductive porous heating unit is configured as a plate structure inlaid in a middle of a side wall of the porous liquid transfer unit, or the magnetically conductive porous heating unit configured as a cylindrical structure inlaid in a middle of an inner wall or an outer wall of the porous liquid transfer unit;
the atomization surface of the magnetically conductive porous heating unit extends out of a side surface of the porous liquid transfer unit or is flush with the side surface of the porous liquid transfer unit.

15. The atomization heating assembly according to claim 14, wherein a liquid inflow surface arranged on the porous liquid transfer unit is at least one of a flat surface, a curved surface and a groove surface, and the atomization surface is at least one of a flat surface and a curved surface.

16. The atomization heating assembly according to claim 1, wherein a liquid transfer hole or a liquid transfer groove is formed in a liquid inflow surface of the porous liquid transfer unit.

17. An atomization heating device, comprising a housing, a mouthpiece and a liquid tank, wherein the atomization heating assembly according to claim 1 is arranged below the liquid tank, and a sealing element is arranged between the atomization beating assembly and the liquid tank.
